(19) United States
(12) Patent Application Publication
(10) Pub. No.: US 2017/0016586 A1
(43) Pub. Date: Jan. 19, 2017

(54) LIGHT SOURCE MODULE AND VEHICLE LAMP

(71) Applicant: Koito Manufacturing Co., Ltd., Tokyo (JP)

(72) Inventors: Toshiaki TSUDA, Shizuoka-shi (JP); Noriko SATO, Shizuoka-shi (JP); Misako NAKAZAWA, Shizuoka-shi (JP)

(73) Assignee: Koito Manufacturing Co., Ltd., Tokyo (JP)

(21) Appl. No.: 15/278,985

(22) Filed: Sep. 28, 2016

Related U.S. Application Data
(63) Continuation of application No. PCT/JP2015/063169, filed on May 7, 2015.

(30) Foreign Application Priority Data
May 7, 2014 (JP) 2014-096203
May 22, 2014 (JP) 2014-106484

(51) Int. Cl. F21S 8/10; B60Q 1/068

(52) U.S. Cl. CPC F21S 48/1145; F21S 48/1388; F21S 48/1233; F21S 48/125; F21S 48/1241; F21S 48/328; F21S 48/1721; F21S 48/1742; B60Q 1/0683; F21Y 2115/30

(57) ABSTRACT

A vehicle lamp includes a first light source, a second light source, and a third light source that emit laser beams; a first lens, a second lens, and a third lens that collimate the respective laser beams emitted by the first light source, the second light source, and the third light source; a converging reflector having a reflective surface whose basis is a paraboloid of revolution, and that reflects the respective laser beams transmitted through the first lens, the second lens, and the third lens; and a phosphor that, receiving laser light reflected by the converging reflector, emits light.

### BACKGROUND OF THE INVENTION

1. Field of the Invention

The present invention relates to light source modules and vehicle lamps provided with light source modules.

2. Description of the Related Art

Development of light source modules provided with laser-beam-emitting laser light sources and phosphors that produce optical emission on receiving the laser light, and of vehicle lamps provided with such light source modules, has been ongoing in recent years. In these light source modules, the phosphors are irradiated with a laser beam emitted by the laser light source. Receiving the laser beam, the phosphors emit light. To produce white light, the light that the phosphors emit is color-mixed, or the phosphor-emitted light is color-mixed with the laser beam. The white light, illuminating forward of the lamp, forms a predetermined light-distribution pattern. To date, light source modules and vehicle lamps such as described in JP2011-243373 and JP2009-260053, for example, have been proposed.

Although the luminance of laser light sources generally is high, the luminous flux is low, so that realizing the luminous flux demanded of a vehicle lamp requires employing a plurality of laser light sources, and converging the laser beams from the plurality of laser light sources and shining them onto the phosphors.

Concentrating the beams by means of an optical waveguide is one way to converge laser beams from a plurality of laser light sources. Nevertheless, situations where beams are concentrated by means of an optical waveguide can give rise to laser-light losses when the light enters, when it is guided through, and when it exits the waveguide.

Vehicle lamps configured to form a light-distribution pattern having a cutoff line have been known to date. As light sources for such vehicle lamps, a conventional light source module such as that described in JP2009-260053 has room for improvement.

### SUMMARY OF THE INVENTION

One of the objectives of the present invention, brought about taking such circumstances into consideration is to make available technology whereby laser light from a laser light source may be exploited efficiently.

Further, another one of the objectives of the present invention is to make available a light source module adapted as a light source in a vehicle lamp.

In order to resolve the issues discussed above, a vehicle lamp according to an aspect of the present invention includes a plurality of laser-beam emitting light sources, transmissive elements for collimating the respective laser beams emitted by the plurality of light sources, a first optical component having a reflective surface, whose basis is a paraboloid of revolution, that reflects the respective laser beams transmitted through the transmissive elements, a light-emitting member that, receiving laser light reflected by the first optical component, emits light, and a second optical component that radiates the light from the light-emitting member forward of the lamp.

In another aspect the present invention is a light source module. The light source module includes a plurality of laser-beam emitting light sources, transmissive elements for collimating the respective laser beams emitted by the plurality of light sources, an optical member having a reflective surface, whose basis is a paraboloid of revolution, that reflects the respective laser beams transmitted through the transmissive elements, and a light-emitting member that, receiving laser light reflected by the optical member, emits light.

The present invention is also a light source module in a further, separate aspect. The light source module includes a laser-beam emitting light source, a phosphor that, receiving laser light from the light source, emits light, and a retaining member that retains the phosphor. The retaining member includes a through-hole having an inclined wall surface. The phosphor is disposed such that a lateral surface thereof is in contact with the inclined wall surface of the through-hole. An emission surface of the phosphor is of oblong form, with its outer peripheral sides including a pair of longitudinally extending linear sides.

### BRIEF DESCRIPTION OF THE DRAWINGS

Embodiments will now be described by way of examples only, with reference to the accompanying drawings which are meant to be exemplary, not limiting and wherein like elements are numbered alike in several figures in which:

FIG. 1 is a sectional view illustrating a vehicle lamp according to a first embodiment;

FIG. 2 is a sectional view illustrating a lamp unit illustrated in FIG. 1;

FIGS. 3A and 3B illustrate a phosphor module and the vicinity thereof;

FIG. 4 is an illustration for describing a relationship among the shape of an opening in a holding member, the shape of an incident surface of a phosphor, the shape of an emission surface of the phosphor, and the shapes of laser beams emitted by respective light sources;

FIG. 5 is a sectional view illustrating a lamp unit of a vehicle lamp according to a second embodiment;

FIG. 6 is a sectional view illustrating a vehicle lamp according to a third embodiment;

FIG. 7 is a sectional view illustrating a lamp unit of a vehicle lamp according to a fourth embodiment;

FIG. 8 is a sectional view illustrating a lamp unit of a vehicle lamp according to a modification;

FIGS. 9A and 9B illustrate a phosphor module of a vehicle lamp according to a modification; and

FIGS. 10A and 10B illustrate a phosphor module of a light source module according to a modification.

### DETAILED DESCRIPTION OF THE INVENTION

The invention will now be described by reference to the preferred embodiments. This does not intend to limit the scope of the present invention but to exemplify the invention. The size of the component in each figure may be changed in order to aid understanding. Some of the components in each figure may be omitted if they are not important for explanation.

### First Embodiment

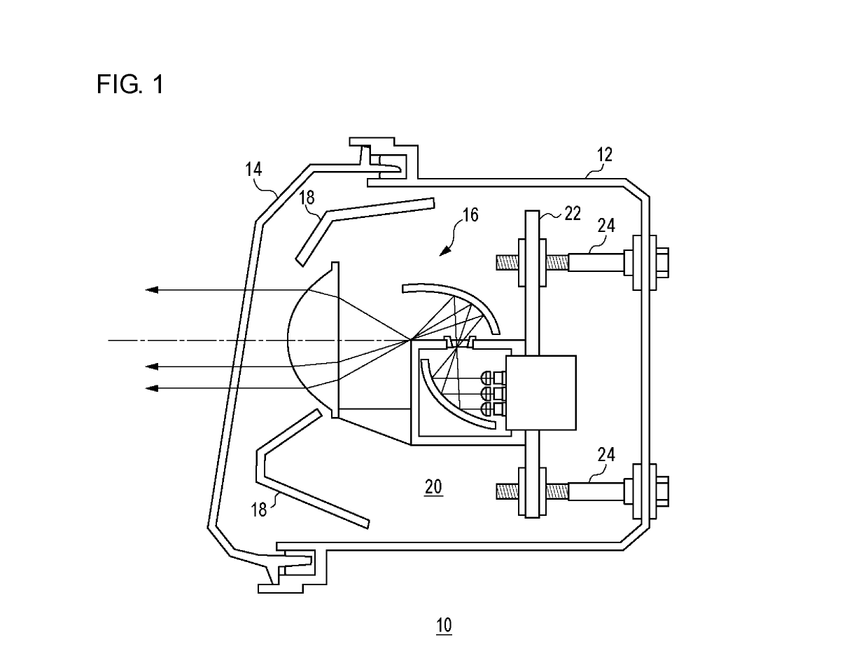

FIG. 1 is a sectional view illustrating a configuration of a vehicle lamp 10 according to a first embodiment. The vehicle lamp 10 is used as a vehicle headlamp. The vehicle lamp 10 is disposed at each of the right and left sides in the front portion of a vehicle body. In the present embodiment, the vehicle lamp 10 located on the right side as viewed from the front of the vehicle body will be described. The vehicle lamp 10 on the left side basically has the same configuration.

The vehicle lamp 10 includes a lamp body 12, a translucent cover 14, a lamp unit 16, and an extension reflector 18. The lamp body 12 is formed into a box shape having an opening. The translucent cover 14 is formed of translucent resin or glass and formed into a bowl shape. The translucent cover 14 is mounted to the lamp body 12 so as to cover the opening in the lamp body 12.

The lamp unit 16 is disposed in a lamp room 20 formed by the lamp body 12 and the translucent cover 14. The lamp unit 16 is a so-called projector-type optical unit. The lamp unit 16 is mounted to a metal support member 22 at substantially the center thereof, and the metal support member 22 is disposed such that the principal surfaces thereof face the depth-wise direction of the lamp. The metal support member 22 is tiltably supported to the lamp body 12 by aiming screws 24. Rotating the aiming screws 24 causes the metal support member 22 to tilt, and the lamp unit 16 tilts in association therewith. Thus, the optical axis of the lamp unit 16 can be adjusted in the horizontal direction and in the vertical direction.

The extension reflector 18 is disposed in the lamp room 20, similarly to the lamp unit 16. Specifically, the extension reflector 18 is disposed so as to cover a region between the opening in the lamp body 12 and the outer periphery of the lamp unit 16. Thus, the internal structure of the vehicle lamp 10 can be hidden.

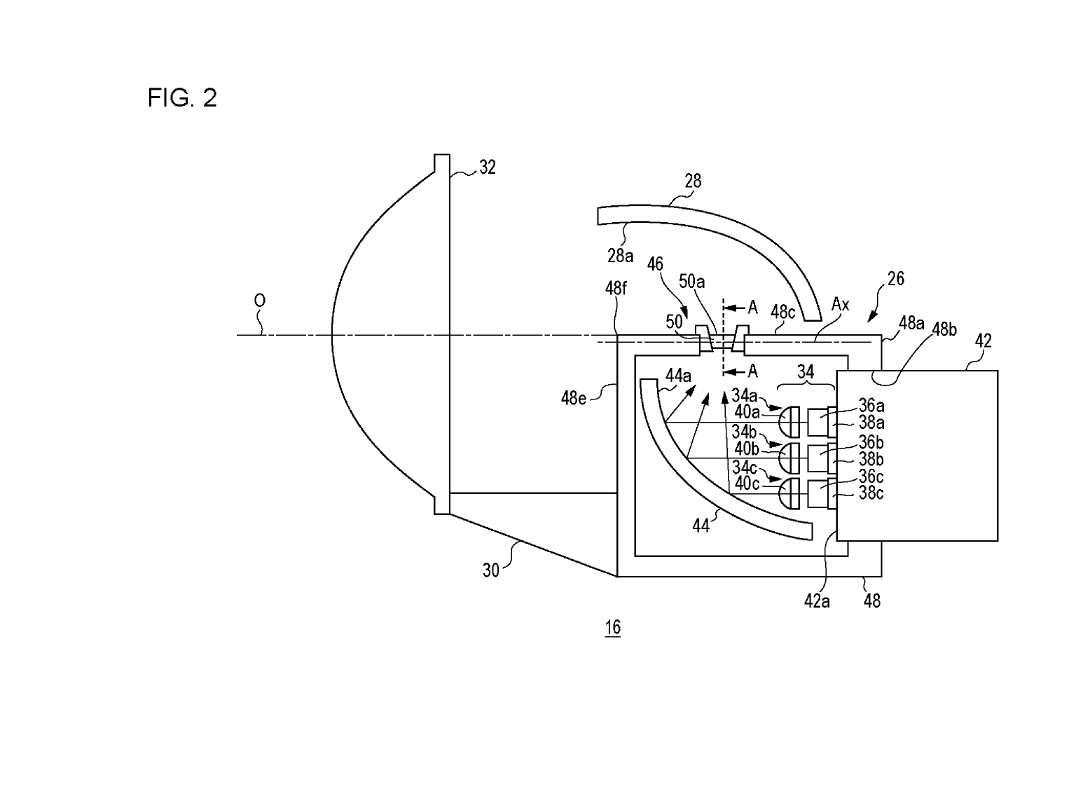

FIG. 2 is a sectional view illustrating the lamp unit 16 illustrated in FIG. 1. The lamp unit 16 includes a light source module 26, a reflector 28, a lens holder 30, and a projection lens 32.

The reflector 28 is a substantially dome-shaped member and is disposed above the light source module 26. Specifically, the reflector 28 is disposed so as to oppose an emission surface 50a of a phosphor 50 (described later). The reflector 28 has a reflective surface 28a provided on an inner side thereof, and the reflective surface 28a has a shape that is based on an ellipsoid of revolution. The reflective surface 28a has a first focal point and a second focal point that is located closer to the front side of the lamp than the first focal point. The positional relationship of the reflector 28 and the phosphor 50 is set such that the first focal point of the reflective surface 28a substantially lies on the phosphor 50.

The lens holder 30 is a member that extends in the depthwise direction. The lens holder 30 is fixed at its back side to the light source module 26. The projection lens 32 is fixed to the front side of the lens holder 30. The projection lens 32 is a plano-convex aspherical lens having a convex front surface and a planar rear surface. The projection lens 32 projects a light source image formed on a posterior focal plane that contains the posterior focal point of the projection lens 32 onto a virtual vertical screen in front of the lamp in the form of an inverted image.

The light source module 26 includes a light source unit 34, a heat sink 42, a condensing reflector 44, a phosphor module 46, and a case 48. The case 48 is formed into a box shape. The case 48 houses the light source unit 34 and the condensing reflector 44.

The light source unit 34 includes a first light source unit 34a, a second light source unit 34b, and a third light source unit 34c. The first light source unit 34a includes a first light source 36a, a first substrate 38a, and a first lens 40a. The first light source 36a is a laser diode that emits a blue laser beam. In the present embodiment, the first light source 36a is a laser diode having its peak wavelength in a wavelength range from 380 nm to 470 nm. The first light source 36a may also be a laser device, such as a solid-state laser or a gas laser.

The first substrate 38a is mounted to a front surface 42a of the heat sink 42. The first light source 36a is mounted on the first substrate 38a such that the laser emission surface faces toward the front of the lamp. The first lens 40a is provided between the first light source 36a and the condensing reflector 44. The first lens 40a converts a laser beam traveling from the first light source 36a toward the condensing reflector 44 into a parallel light beam. The first lens 40a may be provided with a function that enables the tilt angle in the vertical direction to be adjusted. In this case, a cant error associated with a dimension error or the like of the first substrate 38a can be corrected.

The second light source unit 34b includes a second light source 36b, a second substrate 38b, and a second lens 40b.

The third light source unit 34c includes a third light source 36c, a third substrate 38c, and a third lens 40c.

The second light source 36b and the third light source 36c each have a configuration similar to that of the first light source 36a.

The second substrate 38b and the third substrate 38c each have a configuration similar to that of the first substrate 38a.

The second lens 40b and the third lens 40c each have a configuration similar to that of the first lens 40a. The second lens 40b and the third lens 40c may each be provided with a function that enables the tilt angle in the vertical direction to be adjusted.

The heat sink 42 is formed of a material with a high heat transfer coefficient, such as aluminum. The front surface 42a of the heat sink 42 has a planar shape. On this front surface 42a, the first substrate 38a on which the first light source 36a is mounted, the second substrate 38b on which the second light source 36b is mounted, and the third substrate 38c on which the third light source 36c is mounted are mounted. To put it the other way around, the first substrate 38a, the second substrate 38b, and the third substrate 38c are disposed such that their rear sides are located on the same plane, and thus the front surface 42a of the heat sink 42 can be formed into a planar shape.

The heat sink 42 is provided such that the side where the front surface 42a is slightly enters into the case 48 through a through-hole 48b formed in a back surface 48a of the case 48 and the remaining portion of the heat sink 42 projects toward the outside of the case 48. Thus, heat generated in the light sources can be dissipated to the outside of the case 48, and a rise in the temperature of the light sources and the light source module 26 in turn can be suppressed.

The condensing reflector 44 is provided in front of the light source unit 34. The condensing reflector 44 has a reflective surface 44a. The reflective surface 44a has a shape that is based on a paraboloid of revolution with its center axis on an axis Ax passing through the phosphor 50.

The light source unit 34 is disposed such that laser beams from the light source unit 34 are incident on the reflective surface 44a in substantially parallel to the axis Ax. The phosphor 50 is disposed such that the focal point of the reflective surface 44a lies on the phosphor 50. Specifically, the phosphor 50 is disposed such that the center thereof substantially coincides with the focal point of the reflective surface 44a. As the light source unit 34, the reflective surface 44a, and the phosphor 50 are configured in this manner, laser beams from the plurality of light source units 34a, 34b, and 34c are condensed on the phosphor 50.

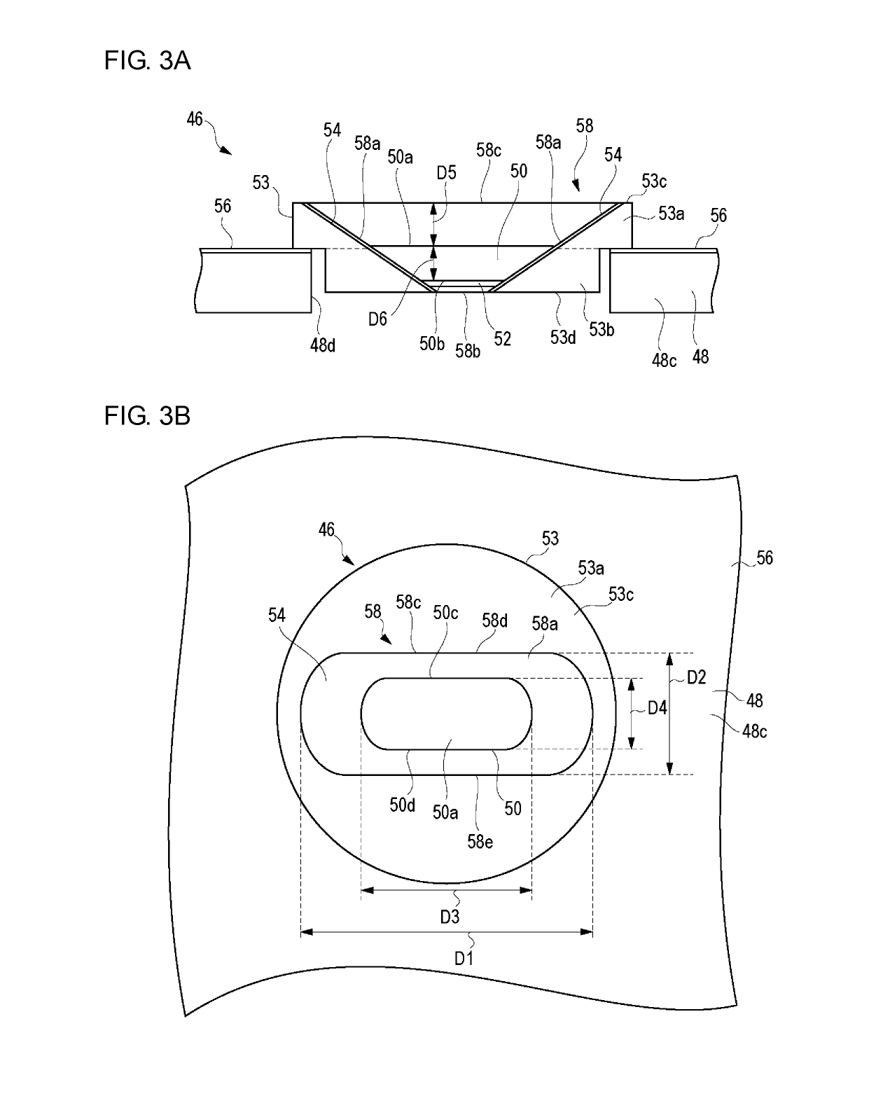

FIGS. 3A and 3B illustrate the phosphor module 46 and the vicinity thereof. FIG. 3A is a sectional view taken along the A-A line indicated in FIG. 2. FIG. 3B is a view in which FIG. 3A is seen from the above. The phosphor module 46 includes the phosphor 50, a wavelength-selection filter 52, and a holding member 53.

The holding member 53 is formed of a variety of metal materials. For example, the holding member 53 is formed of iron, stainless steel (SUS), brass, molybdenum, tungsten, or an alloy of the above. The holding member 53 includes an upper portion 53a and a lower portion 53b that each have a cylindrical outer peripheral surface. The outer peripheral surface of the lower portion 53b has a smaller outer diameter than the outer peripheral surface of the upper portion 53a. A through-hole 48d having a diameter larger (e.g., by several millimeters) than the outer diameter of the lower portion 53b is formed in the upper surface 48c of the case 48. The holding member 53 is fixed to the case 48 in a state in which the lower portion 53b is in the through-hole 48d and the lower surface of the upper portion 53a is placed on the upper surface 48c of the case 48. Specifically, the holding member 53 has its position in the horizontal direction adjusted in a state in which the lower portion 53b is in the through-hole 48d and is fixed to the case 48 by resistance welding, laser welding, arc welding, soldering, or caulking.

A through-hole 58 is formed in the holding member 53 at substantially the center thereof, and an upper surface 53c of the upper portion 53a communicates with a lower surface 53d of the lower portion 53b through the through-hole 58. The through-hole 58 is formed such that its sectional area becomes larger toward the upper side. Therefore, an inner wall 58a of the through-hole 58 is inclined. In the present embodiment, the through-hole 58 is formed such that the shape of the inner wall 58a along a vertical section is linear.

The through-hole 58 is formed such that its sectional shape becomes more elongated toward the upper side. In other words, the through-hole 58 is formed such that the ratio of the dimension in the longitudinal direction to the dimension in the lateral direction along the section becomes larger toward the upper side.

An opening 58b of the through-hole 58 in the lower surface 53d has a substantially circular shape. Meanwhile, an opening 58c of the through-hole 58 in the upper surface 53c has a substantially elliptical shape. Thus, the outer periphery of the opening 58c includes a pair of linear sides 58d and 58e extending in the longitudinal direction of the opening 58c. In addition, the emission surface 50a of the phosphor 50 has a substantially elliptical shape, which will be described later, and thus the shape of the through-hole 58 along a section passing through the emission surface 50a is also substantially elliptical.

The through-hole 58 is formed such that the dimension D1 of the opening 58c in the upper surface 53c in the longitudinal direction is twice to four times the dimension D2 of the opening 58c in the lateral direction. In other words, the opening 58c is formed such that the ratio between the lateral direction and the longitudinal direction is from 1:2 to 1:4.

The phosphor 50 absorbs a portion of blue laser beams from the light source unit 34 and emits yellow light in a Lambertian manner. The remaining portion of the laser beams is emitted from the phosphor 50 without being absorbed by the phosphor 50. The structure of the phosphor 50 is well known, and thus detailed description thereof will be omitted. The yellow light emitted by the phosphor 50 is mixed with the blue laser beams emitted without being absorbed by the phosphor 50, and thus white light is generated. The white light travels toward the reflector 28.

The phosphor 50 has a shape corresponding to the shape of the through-hole 58 in the holding member 53. To put it the other way around, the through-hole 58 in the holding member 53 has a shape corresponding to the shape of the phosphor 50. Specifically, the phosphor 50 is formed such that its sectional area becomes larger toward the upper side. In addition, the phosphor 50 is formed such that its sectional shape becomes more elongated toward the upper side. In other words, the phosphor 50 is formed such that the ratio of the dimension in the longitudinal direction to the dimension in the lateral direction along the section becomes larger toward the upper side.

The emission surface 50a of the phosphor 50 has a substantially elliptical shape. Thus, the outer periphery of the emission surface 50a includes a pair of linear sides 50c and 50d extending in the longitudinal direction. Specifically, the sides 50c and 50d extend in the same direction as the sides 58d and 58e of the opening 58c. In addition, the phosphor 50 is formed such that the dimension D3 of the emission surface 50a in the longitudinal direction is twice to four times the dimension D4 of the emission surface 50a in the lateral direction. In other words, the phosphor 50 is formed such that the ratio between the lateral direction and the longitudinal direction of the emission surface 50a is from 1:2 to 1:4.

The wavelength-selection filter 52 is provided underneath the phosphor 50, or in other words, provided between the phosphor 50 and the light source unit 34. The wavelength-selection filter 52 transmits blue laser beams from the light source unit 34. In addition, the wavelength-selection filter 52 reflects a portion of the yellow light emitted by the phosphor 50 that travels toward the lower side. Thus, the utilization efficiency of the light from the phosphor 50 can be increased.

In the present embodiment, the wavelength-selection filter 52 is a dielectric multilayer film formed on the lower surface of the phosphor 50 through vapor deposition. The dielectric multilayer film is a thin film obtained by alternatingly stacking a number of layers of dielectric substances having different refractive indices. The dielectric multilayer film transmits blue light having a wavelength of 380 nm to 470 nm at a rate of substantially 100% and reflects light having a wavelength of 471 nm to 800 nm at a rate of substantially 100% through the multiple reflection effect and the multiple interference effect. It is to be noted that the reflectance of the dielectric multilayer film with respect to light having a wavelength of 471 nm to 800 nm does not need to be substantially 100%. The reflectance may be, for example, substantially 50% or substantially 80%, or may take another value.

The phosphor 50 and the wavelength-selection filter 52 are inserted in the through-hole 58 such that their side surfaces are in contact with the inner wall 58a of the through-hole 58 and are fixed through press fitting, bonding, or the like. The phosphor 50 and the wavelength-selection filter 52 may be fixed by being sealed with a transparent member made of glass or the like.

A reflective film 54 is provided on the inner wall 58a of the through-hole 58. Thus, the inner wall 58a of the through-hole 58 functions as a reflective surface. Of the light emitted by the phosphor 50 in a Lambertian manner, at least a portion that travels toward the lower side is reflected by this reflective film 54 and travels toward the upper side, or in other words, toward the reflector 28. Thus, the utilization efficiency of the light from the phosphor 50 can be increased.

The inner wall 58a of the through-hole 58 extends higher than the phosphor 50. In other words, the annular reflective surface extends higher than the phosphor 50. This portion of the reflective surface that extends higher than the phosphor 50 makes it possible to provide directionality to the light emitted by the phosphor 50 in a Lambertian manner. This extending annular reflective surface is formed such that the dimension D5 thereof in the vertical direction is 1.2 to 1.8 times the dimension D6 of the phosphor 50 in the vertical direction. More preferably, the stated reflective surface is formed such that the dimension D5 is 1.4 to 1.6 times the dimension D6.

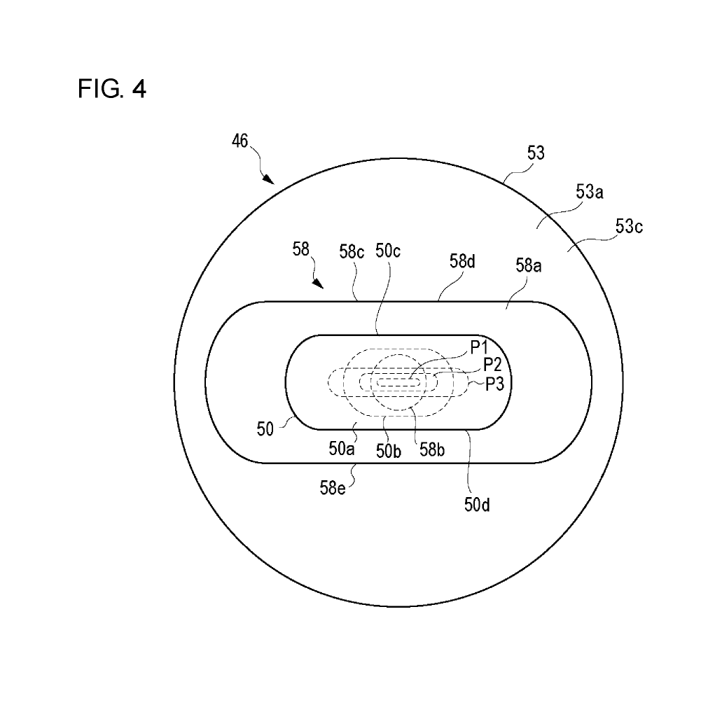

Next, a relationship among the shape of the opening 58b of the through-hole 58, the shape of an incident surface 50b of the phosphor 50, the shape of the emission surface 50a of the phosphor 50, and the shapes of the laser beams emitted from the respective light sources will be described. FIG. 4 is an illustration for describing the stated relationship. FIG. 4 illustrates the phosphor module 46 as viewed from the above. A beam pattern P1 indicates a sectional shape of a laser beam at the opening 58b of the through-hole 58. A beam pattern P2 indicates a sectional shape of the laser beam at the incident surface 50b of the phosphor 50. A beam pattern P3 indicates a sectional shape of the laser beam at the emission surface 50a of the phosphor 50. As illustrated in FIG. 4, the section of the laser beam is elongated, and the laser beam diverges as the distance from the light source increases. It is to be noted that FIG. 4 depicts the thickness and the degree of divergence of the laser beam in an exaggerated manner.

The opening 58b of the through-hole 58 is larger than the beam pattern P1 of the laser beam. In other words, the diameter of the opening 58b is greater than the dimension of the beam pattern P1 of the laser beam in the longitudinal direction. The diameter of the opening 58b may be substantially the same as the dimension of the beam pattern P1 of the laser beam in the longitudinal direction.

The incident surface 50b of the phosphor 50 is larger than the beam pattern P2 of the laser beam. In other words, the dimension of the incident surface 50b in the longitudinal direction is greater than the dimension of the beam pattern P2 of the laser beam in the longitudinal direction. The dimension of the incident surface 50b in the longitudinal direction may be substantially the same as that of the beam pattern P2 of the laser beam.

Referring back to FIG. 2, the case 48 is configured such that the upper surface 48c contains an optical axis O and an edge line 48f formed by the upper surface 48c and a front surface 48e is located in the vicinity of the second focal point of the reflector 28. Light reflected by the reflector 28 is incident on the projection lens 32 through the second focal point of the reflector 28, or in other words, through the vicinity of the edge line 48f. A reflective film 56 is provided on the upper surface 48c of the case 48 (see FIG. 3), and a portion of the light reflected by the reflector 28 is reflected by the reflective film 56. Thus, the light from the reflector 28 is cut with the edge line 48f serving as a boundary. Accordingly, a light-distribution pattern having a cutoff line corresponding to the shape of the edge line 48f is projected onto a space in front of the vehicle. In other words, a portion of the case 48 functions as a shade.

An operation of the vehicle lamp 10 configured as described above will be described.

Upon an instruction to turn on the vehicle lamp 10 being received, the first light source 36a, the second light source 36b, and the third light source 36c emit laser beams. The laser beams are converted into parallel light beams by the first lens 40a, the second lens 40b, and the third lens 40c and are incident on the reflective surface 44a of the condensing reflector 44. The laser beams incident on the condensing reflector 44 are reflected toward substantially the center of the phosphor 50. The phosphor 50 absorbs a portion of the incident laser beams and emits yellow light. The remaining portion of the laser beams is emitted from the phosphor 50 without being absorbed by the phosphor 50. The aforementioned yellow light and the blue laser beams are mixed, which results in white light, and this white light travels toward the reflector 28. The reflective surface 28a of the reflector 28 reflects the white light toward the projection lens 32. The projection lens 32 converts the light from the reflector 28 into substantially parallel light and illuminates a space in front of the lamp with this light.

According to the light source module 26 according to the first embodiment, the emission surface 50a of the phosphor 50 has an elongated shape. Specifically, the outer periphery of the emission surface 50a of the phosphor 50 includes the pair of linear sides 50c and 50d extending in the longitudinal direction. Thus, when the light source module 26 is used as a light source in the vehicle lamp 10, a cutoff line can be formed with ease. In other words, a light source module suitable for a light source in a vehicle lamp can be achieved.

According to the light source module 26, the phosphor 50 is formed such that the ratio between the lateral direction D4 and the longitudinal direction D3 of the emission surface 50a is from 1:2 to 1:4. In addition, the upper opening 58c of the through-hole 58 is formed such that the ratio between the lateral direction D2 and the longitudinal direction D1 thereof is from 1:2 to 1:4. In other words, a light source module 26 having an aspect ratio suitable for a light source in a vehicle lamp can be achieved.

According to the light source module 26, the phosphor module 46 is formed such that the dimension D5 of a portion of the reflective surface extending higher than the phosphor 50 in the vertical direction is 1.2 to 1.8 times the dimension D6 of the phosphor 50 in the vertical direction. More preferably, the phosphor module 46 is formed such that the dimension D5 is 1.4 to 1.6 times the dimension D6. With this configuration, a light source module having a desired size and desired luminance can be achieved.

According to the light source module 26, the phosphor 50 is formed such that its sectional area becomes larger toward the upper side. In addition, the through-hole 58 in the holding member 53 is formed into a shape that corresponds to the shape of the phosphor 50 and whose sectional area becomes larger toward the upper side. In other words, the through-hole 58 in the holding member 53 is formed so as not to allow the phosphor 50 pass therethrough. The phosphor 50 is held by the through-hole 58 formed in this manner, and thus the phosphor 50 can be prevented from falling off from the holding member 53.

According to the light source module 26, laser beams from the plurality of light source units 34a, 34b, and 34c are condensed onto the phosphor 50 by the reflective surface 44a of the condensing reflector 44. Therefore, there is no loss of the laser beams that could occur when the laser beams are condensed by a light-guide member, such as an optical fiber, at the time when the laser beams enter, propagate through, and are emitted from the light-guide member. Thus, the utilization efficiency of the laser beams improves. In addition, as compared to a case in which the laser beams are condensed by a light-guide member, such as an optical fiber, the size of the light source module 26 can be reduced, and the size of the vehicle lamp 10 in which the light source module 26 is mounted can be reduced in turn.

According to the light source module 26, laser beams from the plurality of light source units 34a, 34b, and 34c are condensed onto the phosphor 50 by the reflective surface 44a that is based on a paraboloid of revolution. Thus, the laser beams can be condensed onto the phosphor 50 as long as the laser beams from the light source unit 34 are incident on the reflective surface 44a in substantially parallel to the axis Ax, which is the center axis of the reflective surface 44a. In other words, as long as the laser beams from the light source unit 34 are substantially parallel to the axis Ax, neither the distance between the members constituting the light source unit 34 and the axis Ax nor the distance between the members and the reflective surface 44a matters. Accordingly, the position of the light source unit 34 can be adjusted relatively with ease.

According to the light source module 26, the first light source 36a, the second light source 36b, and the third light source 36c are housed in the case 48. Thus, even if any of these light sources falls off, a laser beam is not directly emitted to the outside of the light source module 26, and in turn a laser beam can be prevented from being emitted directly to the outside of the vehicle lamp 10 in which the light source module 26 is mounted.

According to the light source module 26, the first substrate 38a, the second substrate 38b, and the third substrate 38c are disposed such that their surfaces facing toward the heat sink 42 are located on the same plane, and thus the front surface 42a of the heat sink 42 can be made planar. Thus, the heat sink 42 can be formed by a single member into a relatively simple shape, and the number of components of the heat sink 42 and the processing cost thereof can be reduced.

### Second Embodiment

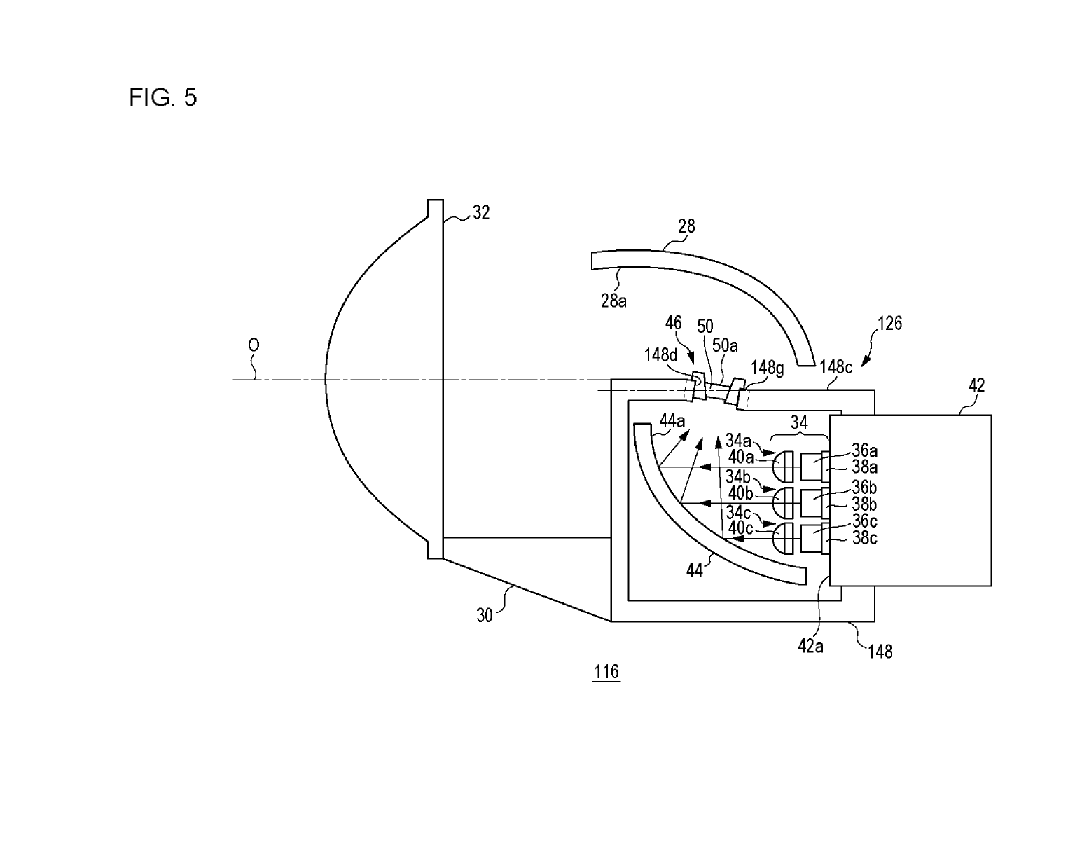

A vehicle lamp according to a second embodiment differs from the vehicle lamp 10 according to the first embodiment primarily in the shape of the light source module. FIG. 5 is a sectional view illustrating a lamp unit 116 of the vehicle lamp according to the second embodiment. FIG. 5 corresponds to FIG. 2.

The lamp unit 116 includes a light source module 126, the reflector 28, the lens holder 30, and the projection lens 32. The light source module 126 includes the light source unit 34, the heat sink 42, the condensing reflector 44, the phosphor module 46, and a case 148. The case 148 is formed into a box shape. The case 148 houses the light source unit 34 and the condensing reflector 44.

An upper surface 148c of the case 148 includes an inclined portion 148g that is inclined toward the rear side. A through-hole 148d is formed in the inclined portion 148g. The phosphor module 46 is fixed into the through-hole 148d, similarly to the first embodiment. Specifically, the phosphor module 46 is fixed such that the emission surface 50a of the phosphor 50 is inclined toward the rear side relative to the center axis of the reflective surface 28a of the reflector 28. In the present embodiment, the center axis of the reflective surface 28a substantially coincides with the optical axis O.

The light source module 126 according to the second embodiment provides effects similar to the effects provided by the light source module 26 according to the first embodiment. In addition, the vehicle lamp according to the second embodiment provides effects similar to the effects provided by the vehicle lamp 10 according to the first embodiment. Furthermore, according to the vehicle lamp according to the second embodiment, the emission surface 50a of the phosphor 50 is fixed so as to be inclined toward the rear side relative to the center axis of the reflective surface 28a of the reflector 28. Thus, the solid angle to be used of the reflective surface 28a of the reflector 28 can be increased.

### Third Embodiment

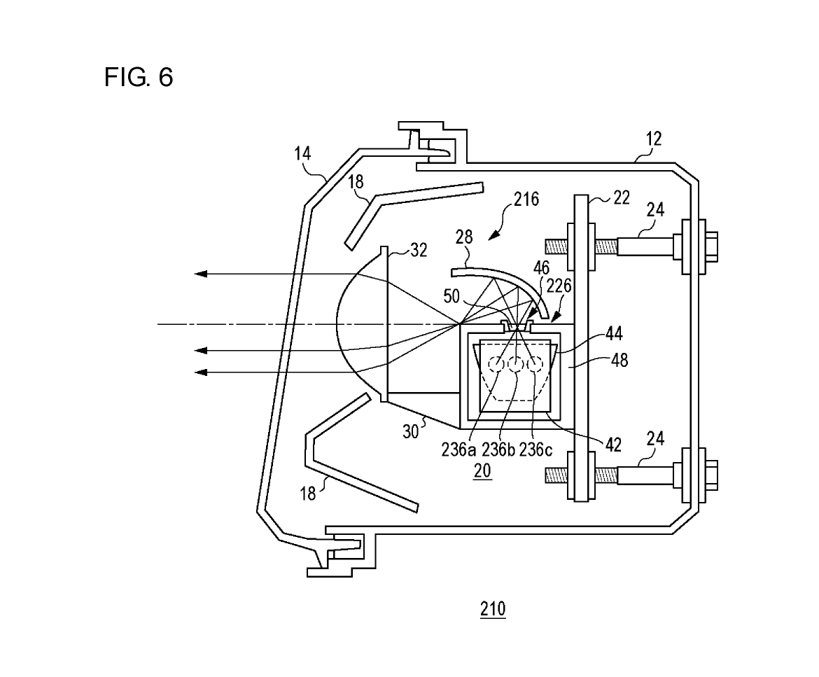

A vehicle lamp according to a third embodiment differs from the vehicle lamp 10 according to the first embodiment primarily in the configuration of the lamp unit. FIG. 6 is a sectional view illustrating a vehicle lamp 210 according to the third embodiment. FIG. 6 corresponds to FIG. 1.

The vehicle lamp 210 includes the lamp body 12, the translucent cover 14, a lamp unit 216, and the extension reflector 18. The lamp unit 216 includes a light source module 226, the reflector 28, the lens holder 30, and the projection lens 32. In the present embodiment, a first light source 236a, a second light source 236b, and a third light source 236c of the light source module 226 are arrayed in the depth-wise direction and disposed such that the laser emission ports thereof face toward the lamp body 12 (horizontal direction in FIG. 6).

The light source module 226 according to the third embodiment provides effects similar to the effects provided by the light source module 26 according to the first embodiment. In addition, the vehicle lamp 210 according to the third embodiment provides effects similar to the effects provided with the vehicle lamp 10 according to the first embodiment. Furthermore, according to the vehicle lamp 210 according to the third embodiment, the light sources are disposed such that their emission ports face toward the lamp body 12. Thus, even if the case 48 and the condensing reflector 44 fall off, laser beams from the light sources are prevented from being emitted directly to the outside of the lamp.

### Fourth Embodiment

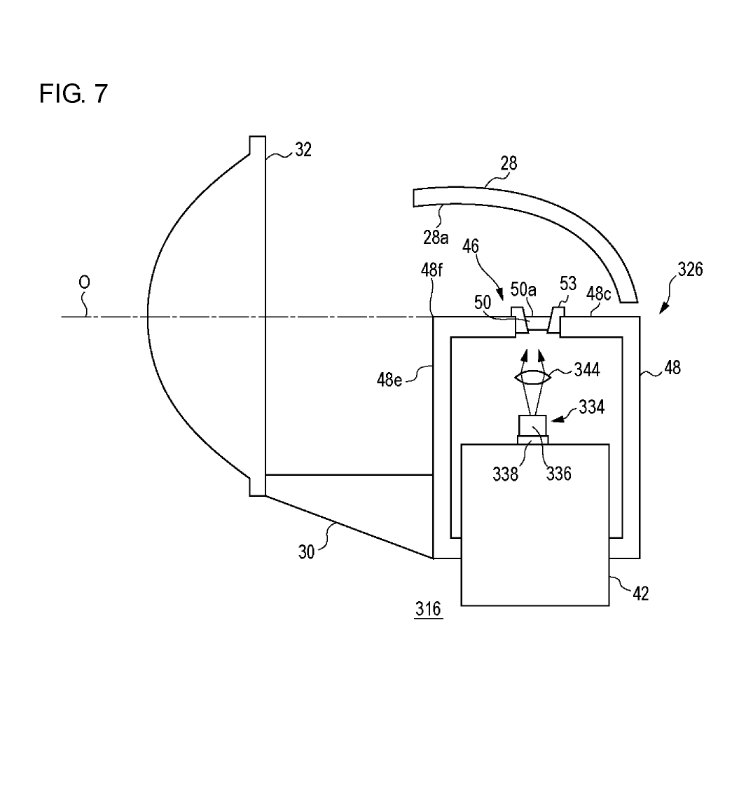

A vehicle lamp according to a fourth embodiment differs from the vehicle lamp 10 according to the first embodiment primarily in the configuration of the light source module. FIG. 7 is a sectional view illustrating a lamp unit 316 of the vehicle lamp according to the fourth embodiment. FIG. 7 corresponds to FIG. 2.

The lamp unit 316 includes a light source module 326, the reflector 28, the lens holder 30, and the projection lens 32. The light source module 326 includes a light source unit 334, the heat sink 42, a condenser lens 344, the phosphor module 46, and the case 48. The case 48 houses the light source unit 334 and the condenser lens 344. The light source unit 334 includes a light source 336 and a substrate 338. The light source 336 and the substrate 338 correspond, respectively, to the first light source 36a and the first substrate 38a of the first embodiment.

The condenser lens 344 is provided between the light source 336 and the phosphor 50. A laser beam emitted by the light source 336 is condensed by the condenser lens 344 and is incident on the phosphor 50. The vehicle lamp 10 may include a lens that converts a laser beam emitted by the light source 336 into a parallel light beam, in place of the condenser lens 344.

The light source module 326 according to the fourth embodiment provides effects similar to the effects provided by the light source module 26 according to the first embodiment. In addition, the vehicle lamp according to the fourth embodiment provides effects similar to the effects provided by the vehicle lamp 10 according to the first embodiment.

Thus far, the present invention has been described on the basis of embodiments. These embodiments are merely illustrative, and it should be appreciated by a person skilled in the art that various modifications can be made to the combinations of the constituent elements and processing processes of the embodiments and that such modifications also fall within the scope of the present invention.

### First Modification

A case in which the light source module 26 includes three light source units, namely, the first light source unit 34a, the second light source unit 34b, and the third light source unit 34c has been described in the first through third embodiments, but this is not a limiting example. The light source module 26 may include two light source units or four or more light source units.

### Second Modification

A case in which the light source units are arrayed in the vertical direction has been described in the first and second embodiment, and a case in which the light source units are arrayed in the depth-wise direction has been described in the third embodiment. These, however, are not limiting examples. For example, in the first embodiment, the light source units may be arrayed in the horizontal direction (the direction of the paper plane of FIG. 2). Alternatively, four or more light source units may be arrayed in a matrix, for example. As another alternative, five or more light source units may be arrayed crosswise, for example. The light source units may be arrayed randomly. In other words, it suffices that a plurality of light source units be disposed such that laser beams therefrom are incident on the reflective surface 44a in substantially parallel to the axis Ax.

### Third Modification

A case in which the light source unit emits a blue laser beam, the phosphor 50 emits yellow light upon absorbing the blue laser beam, and this yellow light is mixed with the blue laser beam to generate white light has been described in the first through fourth embodiments, but this is not a limiting example. For example, the light source unit may emit an ultraviolet laser beam, and the phosphor may emit blue light and yellow light upon absorbing the ultraviolet laser beam. In this case, the blue light and the yellow light emitted by the phosphor are mixed, and white light is generated.

Alternatively, for example, the light source unit may emit an ultraviolet laser beam, and the phosphor may emit red light, green light, and blue light upon absorbing the ultraviolet laser beam. In this case, the red light, the green light, and the blue light emitted by the phosphor are mixed, and white light is generated.

### Fourth Modification

Although not specifically described in the first through third embodiments, at least one of the plurality of light source units may be provided such that a laser beam from that light source unit is incident substantially normally on the emission surface 50a of the phosphor 50. In this case, the emission loss at the emission surface 50a of the phosphor 50 is suppressed, and the utilization efficiency of the light improves.

### Fifth Modification

A case in which the lamp unit is a so-called projector-type optical unit has been described in the first through fourth embodiments, but this is not a limiting example. The lamp unit may be, for example, a so-called parabolic optical unit.

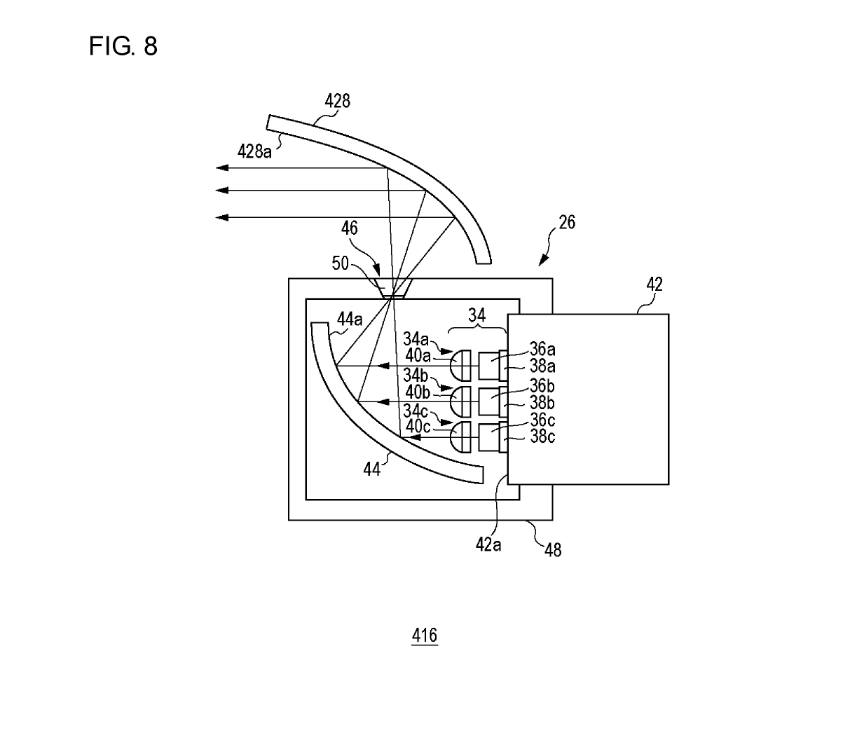

FIG. 8 is a sectional view illustrating a lamp unit 416 of a vehicle lamp according to a modification. FIG. 8 corresponds to FIG. 2. The lamp unit 416 includes a so-called parabolic light source module 26 and a reflector 428. The reflector 428 is a substantially dome-shaped member and is disposed above the light source module 26. The reflector 428 has a reflective surface 428a provided on an inner side thereof, and the reflective surface 428a has a shape that is based on a paraboloid of revolution. The positional relationship of the reflector 428 and the phosphor 50 is set such that the focal point of the reflective surface 428a lies on the phosphor 50. The reflector 428 illuminates a space in front of the lamp with light from the light source module 26.

According to the present modification, effects similar to the effects provided by the light source module 26 according to the embodiments are provided.

### Sixth Modification

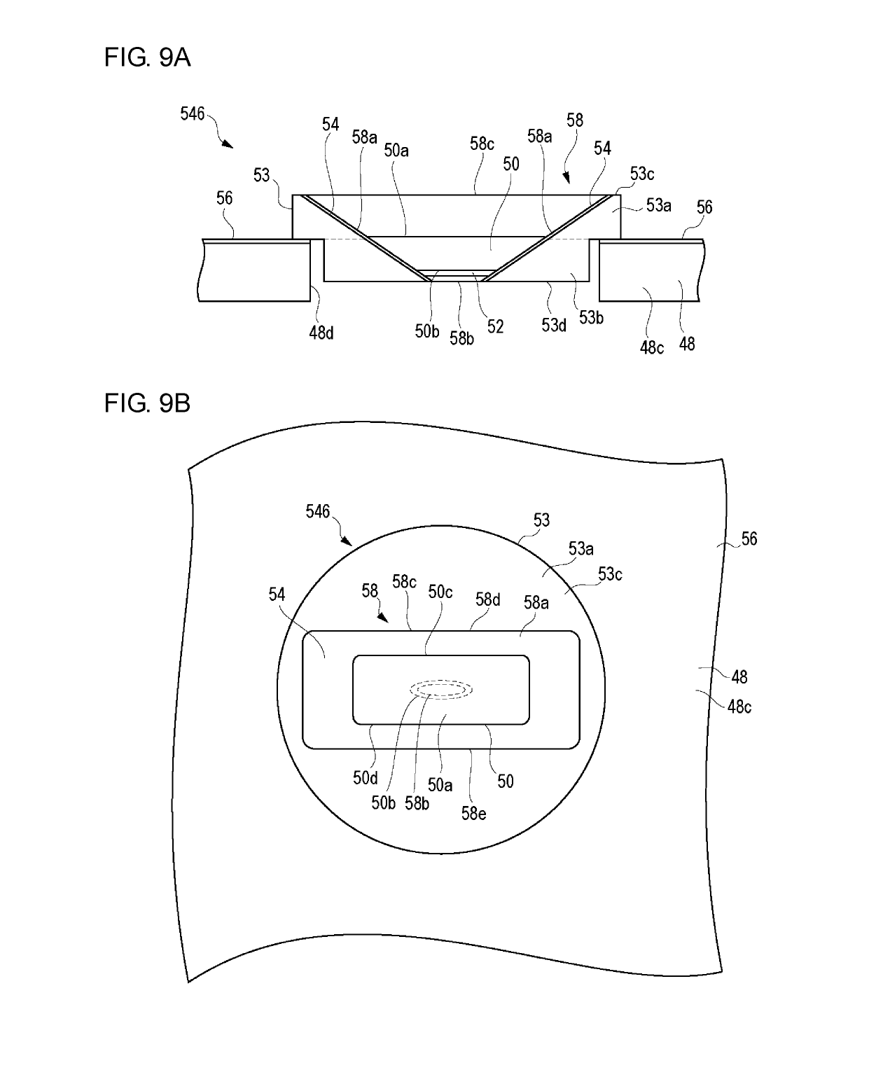

FIGS. 9A and 9B illustrate a phosphor module 546 of a light source module according to a modification. FIGS. 9A and 9B correspond to FIGS. 3A and 3B, respectively. A case in which the opening 58b of the through-hole 58 in the lower surface 53d is substantially circular has been described in the first through fourth embodiments, but this is not a limiting example. As illustrated in FIG. 9B, the opening 58b may have an elongated shape. Specifically, the opening 58b may be formed into a shape that is substantially the same as the sectional shape of the laser beam at the opening 58b or a shape that is substantially similar to the sectional shape of the laser beam at the opening 58b.

In addition, although not specifically described in the first through fourth embodiments, the incident surface 50b may be formed into a shape that is substantially the same as the sectional shape of the laser beam at the incident surface 50b or a shape that is substantially similar to the sectional shape of the laser beam at the incident surface 50b.

A case in which the emission surface 50a of the phosphor 50 has an elliptical shape has been described in the first through fourth embodiments, but this is not a limiting example. As illustrated in FIG. 9B, the emission surface 50a may, for example, have a substantially rectangular shape. In other words, it suffices that the emission surface 50a have an elongated shape and that the outer periphery thereof include a pair of linear sides extending in the longitudinal direction.

A case in which the upper opening 58c of the through-hole 58 has an elliptical shape has been described in the first through fourth embodiments, but this is not a limiting example. As illustrated in FIG. 9B, the opening 58c may, for example, have a substantially rectangular shape. In other words, it suffices that the opening 58c have an elongated shape and that the outer periphery thereof include a pair of linear sides extending in the longitudinal direction.

According to the present modification, effects similar to the effects provided by the light source module according to the first through fourth embodiments are provided.

### Seventh Modification

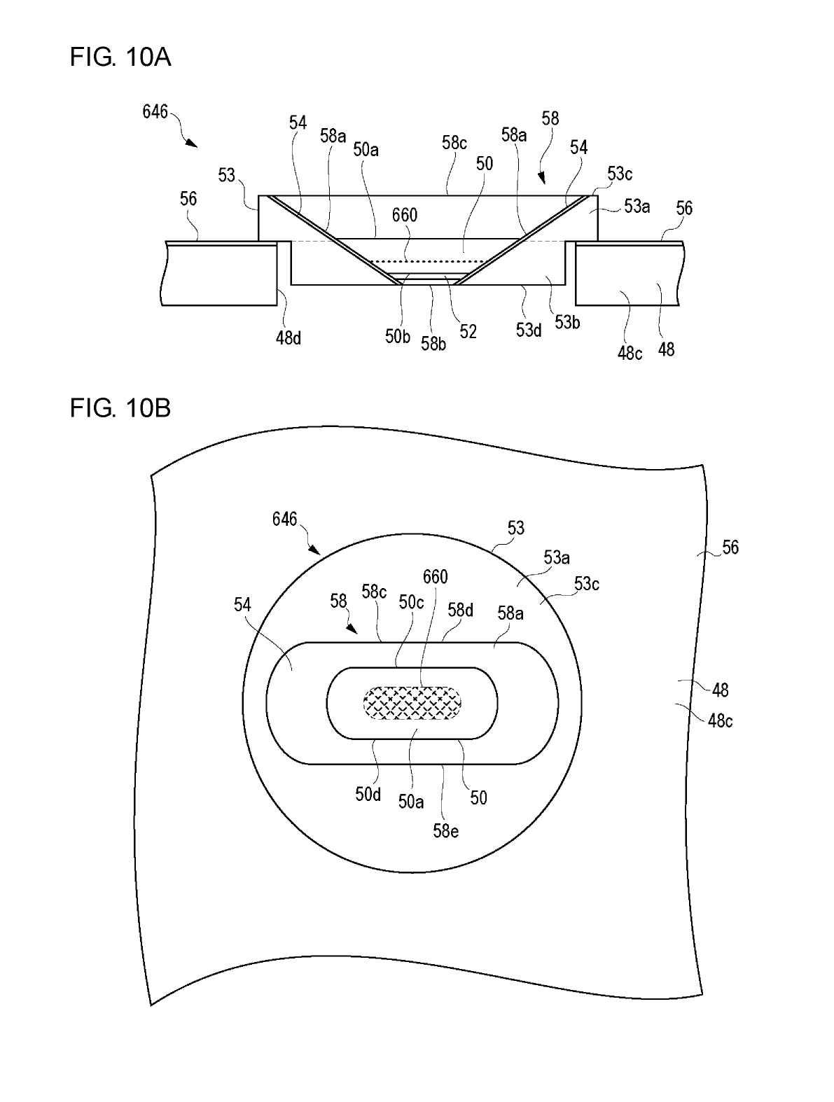

FIGS. 10A and 10B illustrate a phosphor module 646 of alight source module according to a modification. FIGS. 10A and 10B correspond to FIGS. 3A and 3B, respectively. In the present modification, the phosphor 50 is formed integrally with the holding member 53. In other words, the phosphor 50 is formed with the holding member 53 being used as a mold. Specifically, the opening 58b in the lower surface 53d of the holding member 53 is covered, and resin or ceramics containing a phosphor material is injected into the through-hole 58 of which the opening 58b has been covered. Then, the injected material is sintered along the holding member 53, and thus the phosphor 50 is formed.

In the present modification, a metal mesh 660 is coupled to the inner wall 58a of the holding member 53, and the mesh 660 and the phosphor 50 are integrated by forming the phosphor 50 in the manner described above.

According to the present modification, effects similar to the effects provided by the light source module according to the first through fourth embodiments are provided. In addition, according to the present modification, the phosphor 50 is formed by being sintered in a state in which resin or ceramics containing a phosphor material has been injected in the through-hole 58 in the holding member 53. This renders a step of mounting the phosphor 50 into the holding member 53 unnecessary. Furthermore, in the present modification, the phosphor 50 is integrated with the mesh 660 coupled to the holding member 53. Thus, the phosphor 50 is prevented from falling off.

In the present modification, the phosphor 50 is integrated with the metal mesh 660 coupled to the holding member 53. Thus, heat generated in the phosphor 50 is conducted to the holding member 53 through the mesh 660 and dissipated. In other words, according to the present modification, the heat dissipation performance of the phosphor 50 can be increased, and a decrease in the emission efficiency (conversion efficiency of laser beams) of the phosphor 50 in association with heat can be suppressed. As a result, the luminance of the phosphor 50 can be increased, and the light source module can be used suitably for a light source in a vehicle lamp.

In place of the mesh 660, a projection portion may be provided on the inner wall 58a. In this case as well, the projection portion can prevent the phosphor 50 from falling off, and the projection portion can increase the heat dissipation performance of the phosphor 50.

On the basis of the above descriptions, the following aspects of the invention are recognized.

A vehicle lamp according to an aspect of the present invention includes a plurality of light sources that emit laser beams, transmissive elements that convert the respective laser beams emitted by the plurality of light sources to parallel laser beams, a first optical member having a reflective surface that is based on a paraboloid of revolution and that reflects each of the laser beams transmitted through the transmissive elements, a light-emitting member that emits light upon receiving the laser beams reflected by the first optical member, and a second optical member that illuminates a space in front of the lamp with the light from the light-emitting member.

With the reflective surface that is based on a paraboloid of revolution, the laser beams emitted by the plurality of light sources are condensed on the light-emitting member. Accordingly, the laser beams can be used efficiently.

Another aspect of the present invention provides a light source module. This light source module includes a plurality of light sources that emit laser beams, transmissive elements that convert the respective laser beams emitted by the plurality of light sources to parallel laser beams, an optical member having a reflective surface that is based on a paraboloid of revolution and that reflects each of the laser beams transmitted through the transmissive elements, and a light-emitting member that emits light upon receiving the laser beams reflected by the optical member.

With the reflective surface that is based on a paraboloid of revolution, the laser beams emitted by the plurality of light sources are condensed on the light-emitting member. Accordingly, the laser beams can be used efficiently.

A yet another aspect of the present invention also provides a light source module. This light source module includes a light source that emits a laser beam, a phosphor that emits light upon receiving the laser beam from the light source, and a holding member that holds the phosphor. The holding member includes a through-hole having an inclined wall surface. The phosphor is disposed such that a side surface of the phosphor is in contact with the inclined wall surface of the through-hole. An emission surface of the phosphor has an elongated shape, and an outer periphery of the emission surface includes a pair of linear sides extending in a longitudinal direction.

According to this aspect, the outer periphery of the emission surface of the phosphor includes the pair of linear sides extending in the longitudinal direction. Accordingly, when the light source module is used as a light source in a vehicle lamp, a cutoff line can be formed with ease.

What is claimed is:

1. A vehicle lamp, comprising:
a plurality of laser-beam emitting light sources;
transmissive elements for collimating the respective laser beams emitted by the plurality of light sources;
a first optical component having a reflective surface, whose basis is a paraboloid of revolution, that reflects the respective laser beams transmitted through the transmissive elements;
a light-emitting member that, receiving laser light reflected by the first optical component, emits light; and
a second optical component that radiates the light from the light-emitting member forward of the lamp.

2. The vehicle lamp according to claim 1, wherein:
the second optical component is disposed opposing an emission surface of the light-emitting member, and has a reflective surface whose basis is either an ellipsoid of revolution or a paraboloid of revolution and that reflects light from the light-emitting member forward of the lamp; and
the emission surface is inclined rearward with respect to the second-optical-component reflective surface's center axis.

3. The vehicle lamp according to claim 1, further comprising:
a lamp body; and
a translucent cover covering an opening in the lamp body; wherein
each of the plurality of light sources is housed in a lamp chamber formed by the lamp body and the translucent cover and is disposed such that an emission port thereof is directed toward the lamp body.

4. A light source module, comprising:
a plurality of laser-beam emitting light sources;
transmissive elements for collimating the respective laser beams emitted by the plurality of light sources;
an optical member having a reflective surface, whose basis is a paraboloid of revolution, that reflects the respective laser beams transmitted through the transmissive elements; and
a light-emitting member that, receiving laser light reflected by the optical member, emits light.

5. The light source module according to claim 4, wherein at least one of the plurality of light sources is provided such that a laser beam emitted therefrom is incident approximately normal to an emission surface of the light-emitting member.

6. A light source module, comprising:
a laser-beam emitting light source;
a phosphor that, receiving laser light from the light source, emits light; and
a retaining member that retains the phosphor; wherein
the retaining member includes a through-hole having an inclined wall surface,
the phosphor is disposed such that a lateral surface of phosphor is in contact with the inclined wall surface of the through-hole, and
an emission surface of the phosphor is of oblong form, with its outer peripheral sides including a pair of longitudinally extending linear sides.

7. The light source module according to claim 6, wherein:
the laser beam at the emission surface has an oblong form; and
the emission surface's longitudinal orientation approximately coincides with the laser beam's longitudinal orientation.

8. The light source module according to claim 6, wherein an incident surface of the phosphor is of approximately identical or approximately similar form to the laser beam's form at the incident surface.

9. The light source module according to claim 6, wherein:
the inclined wall surface includes an annular reflective surface projecting beyond the emission surface reversely away from the light source; and
an edge portion of the reflective surface reversely away from the light source includes a pair of linear portions extending in the same orientation as the longitudinal orientation of the emission surface.

10. The light source module according to claim 6, wherein the emission surface is formed such that a dimension thereof in the longitudinal direction is twice to four times a dimension thereof in a lateral direction.

11. The light source module according to claim 6, wherein the emission surface has either an approximately elliptical form or an approximately rectangular form.
